(19) United States
(12) Patent Application Publication
(10) Pub. No.: US 2011/0040796 A1
(43) Pub. Date: Feb. 17, 2011

(54) METHOD AND SYSTEM FOR QUERYING AN ONTOLOGY MODEL

(75) Inventors: John J. Shockro, North Attleboro, MA (US); Simon G. Bradley, Southborough, MA (US); Jean-Marie R. Dautelle, Saclay (FR)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(73) Assignee: RAYTHEON COMPANY, Waltham, MA (US)

(21) Appl. No.: 12/851,622

(22) Filed: Aug. 6, 2010

Related U.S. Application Data
(60) Provisional application No. 61/233,220, filed on Aug. 12, 2009.

(51) Int. Cl. G06F 17/30

(52) U.S. Cl. 707/794; 707/E17.099

(57) ABSTRACT

A machine-based method for querying information in an ontology model includes providing an ontology model to represent domain information, executing a query of the ontology model, the query directed to identify desired domain information based on at least one parameter, processing a query result to identify any of the desired domain information, in response to identifying desired domain information, rendering the desired domain information, re-executing the query automatically at a predetermined frequency, and generating an alert message when query results have changed.

### FIELD OF THE INVENTION

The techniques and concepts described herein are directed to ontology-driven information querying and, more particularly, to providing desired information in response to iterative querying of domain information represented in an ontology model.

### BACKGROUND

As is known in the art, persons involved in homeland security, urban operations, and intelligence applications have a need for technology which allows the searching of large amounts of information to obtain needed, desired, and/or necessary information. However, it is relatively difficult for such persons to retrieve only needed information pertinent to a task or a problem at-hand, especially when such information comes from multiple disparate data sources stored in independently managed computer systems.

Current knowledge discovery or search mechanisms rely primarily on looking for keywords in unstructured information or using relational database query languages to get structured database information. Keyword search, however, has low precision and can return irrelevant documents that contain the keywords. Such documents are cumbersome and time-consuming for investigators to review and often provide little, if any, worthwhile information. Also, investigators may find it difficult to express precise and relevant information needs in the form relational database queries.

As is also known in the art, an ontology may be described as the concepts and relationships that are important in a particular domain. In recent years, ontologies have been used and adopted in many business and scientific communities as a way to understand, process, and apply domain-specific knowledge and information. A well-defined ontology can provide a common vocabulary for domain users for communication and information-sharing. In one example, an ontology for motor vehicle traffic represents concepts such as motor vehicles, streets, points-of-interest, time-of-day, traffic volume, and locations. The motor vehicle ontology also represents relationships between the concepts. For example, a motor vehicle is “traveling on” a street and is “located at” a certain location. Each concept may be represented by attribute information, such as a motor vehicle make, model, color, year of manufacture, etc.

An ontology model may be described as a structure for representing an ontology as well as for storing actual ontology elements, or instances, such as two motor vehicles (e.g., a Ford Mustang and a Toyota Prius) a street (e.g., Pleasant Street) and a point-of-interest (Town Hall) of the above-mentioned motor vehicle ontology. An ontology model can also include instances to represent conceptual relationships, such as a Ford Mustang owned by Jim Jones, and/or a Ford Mustang traveling on Main Street. Models can become quite complex as more and more interrelated concepts and instances are added to the model. For example, in the example above, a motor vehicle may have multiple owners and/or be involved in multiple events, such as motor vehicle accidents and crimes.

Ontology models may be represented in a computer, including terms and relationships, and queried using known query languages, such as SPARQL Protocol and RDF Query Language. A relational database may be used to organize concepts into database tables, where instances are the rows of the table, and, for example, keys to interlink the tables to represent conceptual relationships.

### SUMMARY

Persons involved in homeland security, urban operations, and intelligence applications may suffer from missing pieces of information that inhibits or even prevents the output of information that is needed for successful outcomes. Investigators may be severely inhibited by an inability to obtain needed, desired, or necessary information at the right time. Furthermore, investigator efforts to obtain needed information may be limited because of missing data or data inconsistencies. Although the missing data may appear or be identified at a later time, investigators may have moved on to different cases and/or to more pressing problems, especially if investigators are involved with a myriad of tasks during a real-time event. Therefore, investigators may not be aware of updated information that may be of interest to them, which may result in unwanted delays and/or missed opportunities.

In other instances, investigators may become aware of updated information related to a pending case and may redirect their attention to the case. Unfortunately, investigators must “reconnect the dots” and/or re-familiarize themselves with the case (e.g., relevant facts, parties, circumstances, and/or evidence) which can be burdensome, time-consuming, and prone to human error, especially if significant time has passed since the case was last in front of them. For example, investigators may not remember important facts about the case and/or what information they need, or even what information is known and/or relevant.

In general overview, the concepts, techniques, and systems described herein enable persons involved in homeland security, urban operations, and intelligence applications to perform queries against an easy to understand and conceptualize problem domain ontology to receive desired, needed, and/or necessary information. For example, border security investigators may use the inventive concepts, techniques, and systems during the course of an investigation to ask border security questions, such as “who has been crossing the border and is associated with a certain suspect?” Investigators may use this needed information to thwart criminal activities of an organized crime syndicate or a terrorist cell that includes a suspect and his known associates.

The border security question, which may be referred to as a border security query, is performed on a border security ontology model that defines, organizes, and conceptualizes border security information in a way that investigators can readily understand and appreciate. For example, investigators can define relationships in the border security ontology model according to their own needs, desires, and experiences, and can also populate the border security ontology model with their own data (e.g. based on field observations, eye witness accounts, etc.) and/or data from integrated data sources. In some instances, the border security information in the ontology may use standard definitions and formats that can be more easily shared with other agencies and other systems.

The investigator's border security query may not lead to any significant result at the time the investigator executes the query. For example, a query to receive a suspect's associates who have crossed the border may not return any results (i.e., may not return any associates) if no associates have crossed the border. In another example, the returned associates may not have changed between a first query and a second query executed at a later time than the first query. Here, the second query may be insignificant because investigators are already aware of the associates from the first query result and the second query result provides investigators with no additional information regarding border crossings.

In one embodiment, the concepts, techniques, and systems allow investigators to collect and store queries for re-execution at a later time. These queries can continue to execute as a background process, for example, to track and identify important border security updates, while freeing up the investigators to pursue other issues and cases. For example, the query may be re-executed at predetermined time intervals and/or in response to updated border security information. Investigators are notified when the query produces a certain result including desired information.

In this way, the investigator need not waste time reopening a case when no significant border security changes have occurred. Instead, as will be described in detail, the original query is stored and executed as a background process and any desired information is identified and rendered to the investigator. Moreover, the investigator need not attempt to reformulate relevant queries (i.e., query parameters such as parties, facts, circumstances, and/or evidence related to a case), which may save time and resources, especially when investigators must multi-task and are under scheduling constraints.

In one embodiment, a computer implemental system includes an ontology model to represent domain information and a query engine for executing a domain query to receive desired domain information represented in the ontology model. A notifier identifies and renders the desired domain information, which may include, but is not limited to, outputting the desired domain information to a display device where it may be viewed by users. As by way of a non-limiting example, the ontology model may be structured and organized in a relationship database using linked tables and the domain information stored in non-volatile and/or volatile memory. The query engine and notifier may be modules executed in a processor.

One of ordinary skill in the art will readily appreciate the benefits and advantages such a system can provide to persons involved in homeland security, urban operations, and intelligence applications. For example, the system can free up investigators to concentrate on other problems and cases while the query engine executes queries in the background and the notifier determines whether a query result includes desired domain information and, if so, renders it to the investigator. Furthermore, the system may be more responsive to changes in domain status than manual querying. Such increased responsiveness may be critical in mitigating the consequences of a natural disaster or terror event, and/or enabling a competitive business practice or to support an organizational function.

It should be noted that the concepts, techniques, and systems are not limited to any particular domain. For example, the concepts, techniques, and systems may be applied to most any domain space, such as border security, air traffic control, military operations, fleet management, product ordering and distribution, organizational work-flow, etc. For example, the concepts, techniques, and systems may be applied to an air traffic control application to monitor and identify suspicious passenger behavior. An air traffic control ontology model may include air traffic control information, such as current and pending commercial flights, passenger lists, employees, known terror operatives and their associates, tracked cargo and baggage, etc. In such an application, air marshals may desire information related to suspicious activities and behaviors of passengers on a domestic flight. Air marshals, or persons supporting the air marshals, may execute an air traffic control query to receive, identify, and notify the air marshals of any passengers meeting certain parameters, such as those being observed in certain locales, one-way ticket holders, lack of baggage on a long flight, marital status, age range, province of origin, etc.

In one aspect, a machine-based method for querying information in an ontology model includes providing an ontology model which represents domain information, executing a query of the ontology model, the query directed to identify desired domain information based upon at least one parameter, processing a query result to identify any of the desired domain information, and in response to identifying desired domain information, rendering the desired domain information.

In further embodiments, the method includes one or more of the following features: at a predetermined time interval, re-executing the query to receive a new query result, wherein at least a portion of the desired domain information is processed from the new query result; in response to modified domain information, re-executing the query to receive a new query result, wherein at least a portion of the desired domain information is processed from the new query result; the query is stored in a memory to execute at a first time and at a second time different than the first time, and the query result includes a first query result received at the first time, and a second query result received at the second time, wherein processing the desired domain information includes comparing the first query result and the second query result; rendering the desired information includes outputting at least one of: an electronic mail message and an instant text message; the domain information includes domain event information associated with domain events, further including receiving the domain event information, and processing the received domain event information by modifying at least one of instances of the ontology model, and relationships of the ontology model, and; importing domain information into the ontology model, the imported domain information including at least one of an ontology model relationship, and an instance of the ontology model.

In another aspect, a system for querying information in an ontology model includes an ontology model to represent domain information, a query engine to execute a query of the ontology model, the query directed to identify desired domain information based on at least one parameter, and a notifier to process a query result to identify and render any of the desired domain information.

In further embodiments, the system includes one or more of the following features: the query engine re-executes the query at a predetermined time interval to receive a new query result, and at least a portion of the desired domain information is identified from the new query result; in response to modified domain information, the query engine re-executes the query to receive a new query result, and at least a portion of the desired domain information is identified from the new query result; the query is stored in a memory and the query engine executes the stored query at a first time to receive a first query result and at a second time different than the first time to receive a second query result, and the notifier identifies and renders the desired domain information by comparing the first query result and the second query result; the notifier enables the output of at least one of: an electronic mail message and an instant text message; an updater to receive domain event information associated with domain events and to process the received domain event information by modifying at least one of instances of the ontology model, and relationships of the ontology model, and; an importer to import domain information into the ontology model, the imported domain information including at least one of an ontology model relationship, and an instance of the ontology model.

In another aspect, an article includes a storage medium having stored instruction thereon that when executed by a processor result in the following: an ontology model to represent domain information, a query engine to execute a query of the ontology model, the query directed to identify desired domain information based upon at least one parameter, and a notifier to process a query result to identify and render any of the desired domain information.

### BRIEF DESCRIPTION OF THE DRAWINGS

The foregoing features of this the inventive concepts, techniques, and systems may be more fully understood from the following description of the drawings in which:

FIG. 1 is a process flow diagram of an embodiment of a method for querying information in an ontology model;

FIG. 2A is a block diagram of an embodiment of an ontology model and related components of the type which may be used in performance of the method of FIG. 1;

FIG. 2B is a pictorial representation of an embodiment of an ontology model of the type which may be used in performance of the method of FIG. 1;

FIG. 3 is a timeline of an exemplary operation of embodiments of queries, query results, and comparisons according to the concepts described herein;

FIG. 4 is a block diagram of an embodiment of a system for querying an ontology model;

FIG. 5 is a block diagram embodiment of a networked environment for providing desired domain information in an ontology model, and;

FIG. 6 is a block diagram of an exemplary processing system in which an ontology model and querying technique may be implemented.

### DETAILED DESCRIPTION

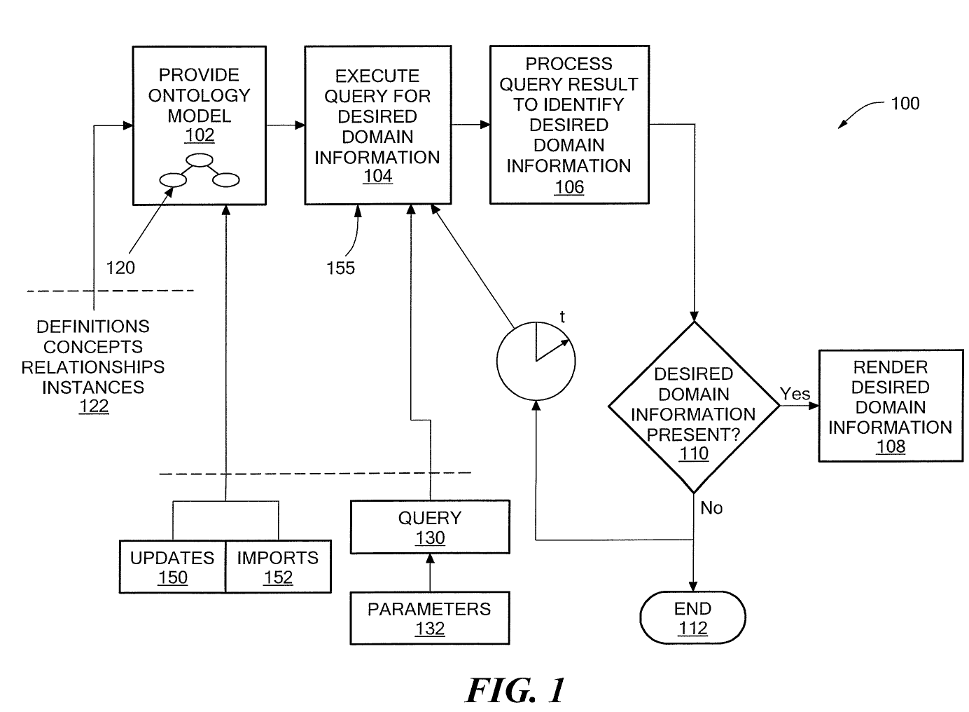

Referring now to FIG. 1, a method 100 for querying information in an ontology model 120 includes providing an ontology model 120 to represent domain information (step 102), executing a query of the ontology model 120 for desired domain information based on at least one parameter (step 104), processing a query result to identify any of the desired domain information (step 106), and rendering the desired domain information (step 108).

The ontology model 120 includes terms and concepts related to a domain space, such as, but not limited to, border security, air traffic control, business practices (e.g., customer relationship management practices), and organizational processes (e.g., product ordering, assembly, distribution, invoicing, etc.). The terms and concepts help involved persons better understand and share information, as well as obtain desired information that may be particularly important to a task-at-hand and/or to mitigate the consequences of an event (e.g., a natural disaster, terror event, accident scene, etc.).

As will be explained in more detail below, the ontology model 120 also includes instances of concepts and relationships between the concepts organized in a model. Various techniques may be used to design and develop the ontology model 120 including the use of standards-based and proprietary building blocks and languages. Some of the methods include user-supplied definitions for domain concepts and relationships (as denoted by reference numeral 122). In particular, domain users may define specific concepts and relationships germane to their problem space, approaches, methodologies, and internal processes. Some, all, or none of the ontological definitions may be imported from existing published ontologies, such as those used to support scientific research, natural language processing, and others.

The ontology model 120 may be structured using any number of techniques, such as a hierarchical model (i.e., an arrangement of concepts and relationships in a tree-like structure comprising upper and lower components), a network model (i.e., a collection of inter-linked concepts and relationships), etc. Such structures may further aide in the visualization of the model 120, such as providing a display of the model 120 in a hierarchical and/or network graph.

A query 130 of the ontology model 120 may be generally described as a prompt or question that relates to domain information that is desired, needed, and/or necessary in order to solve a problem, better understand a domain space, mitigate consequences of an event, support operations, enable intelligent planning, etc. The question may be asked by an involved person, such as a joint responder of an incident (e.g., a law enforcement official at the scene of an accident, fire, crime scene, etc.), a control room operator (e.g., a control operator at a power plant), etc. It will be understood, however, that the question may be posed by a machine to support involved persons. For example, a machine may be programmed to use heuristics to design, build, and generate queries to receive important information.

The query 130 may use any query language suitable for retrieving information from databases and/or information systems and, in particular, for retrieving information from an ontology model. Known query languages to search ontology models include, but are not limited to, SPARQL (which is a recursive acronym for SPARQL Protocol and RDF Query Language). SPARQL is a Resource Definition Framework (RDF) query language for retrieving and/or manipulating data in an RDF. For example, SPARQL may be used to define a query to retrieve associates of members of a terror cell defined in an RDF by supplying the name of the terror cell. Here, the terror cell may be described as a query parameter 132 in that it limits and controls the query results. Still further, a query 130 may be assigned a level of significance, in order to prioritize desired information.

The query result is processed to identify desired information. For example, in some instances, the query result does not retrieve any desired information, as may be the case if no information meets the query parameters 132. Still further, the query result may not include any new information when compared to prior query results. For example, if a list of associates returned from a recent query has not changed from prior queries, then no new associate information exists.

If desired information is identified (step 110), then the method 100 includes rendering the desired information (step 108), which includes, but is not limited to, enabling the display of the desired information to a user, such as outputting the desired information to a display device. In other instances, notifications including the desired information may be provided to users. For example, an electronic mail notification which includes the desired information may be sent to users. In still other instances, the desired information may be rendered to a file for sharing with other users, such as over a network.

The method 100 may terminate (step 112) or the query 130 may be re-executed one or more times. For example, the query 130 may be re-executed at a predetermined time interval t. In some embodiments, the query parameters 132 may be modified to include new concepts and/or relationships defined in the ontology model 120, and/or new instances of the ontology model 120, and/or domain events that modify the model 120.

In the same or different embodiment, the query 130 may be re-executed (i.e., triggered as denoted by line designated by reference numeral 155) by updates 150 to the model 120 and/or data imports 152 into the model 120. For example, a proprietary motor vehicle database including the latest automobile makes and models may be imported into the ontology model 120. An example of an update 150 includes, but is not limited to, a domain user defining a new relationship between concepts in the model 120 and/or entering a new instance of the model 120.

In a further embodiment, the query 130 may be collected and stored in a memory for re-execution. This may be especially useful when the ontology model 120 is incomplete or does not include any domain information that matches the query parameters 132 at the time the query 130 is executed. For example, one or more key concepts may not have been defined for the query 130 to return any results. This may be the case during the planning stages when users are preparing for incident management or know that more domain information will become available in the future and desire to make the necessary preparations for receiving information that they anticipate will be needed. In other scenarios, such as during the immediate aftermath of an event, involved persons may not have had time to define concepts and/or relationships for an ontology model and/or such concepts and relationships may evolve over time as involved persons learn more about the event.

In other instances, users may ask certain questions that do not match any existing information. For example, criminal investigators may ask “who has crossed into the United States that is an associate of a suspect?” or “which vehicles known to be used in a crime syndicate have crossed into the United States?” These queries may not return any query results because no associates or vehicles have crossed into the United States. Here, the query may be saved and re-executed at a later time. If the re-executed query returns any results (i.e. one or more associates and/or vehicles that have crossed into the United States since that last time the query was executed), then the results may be identified and rendered.

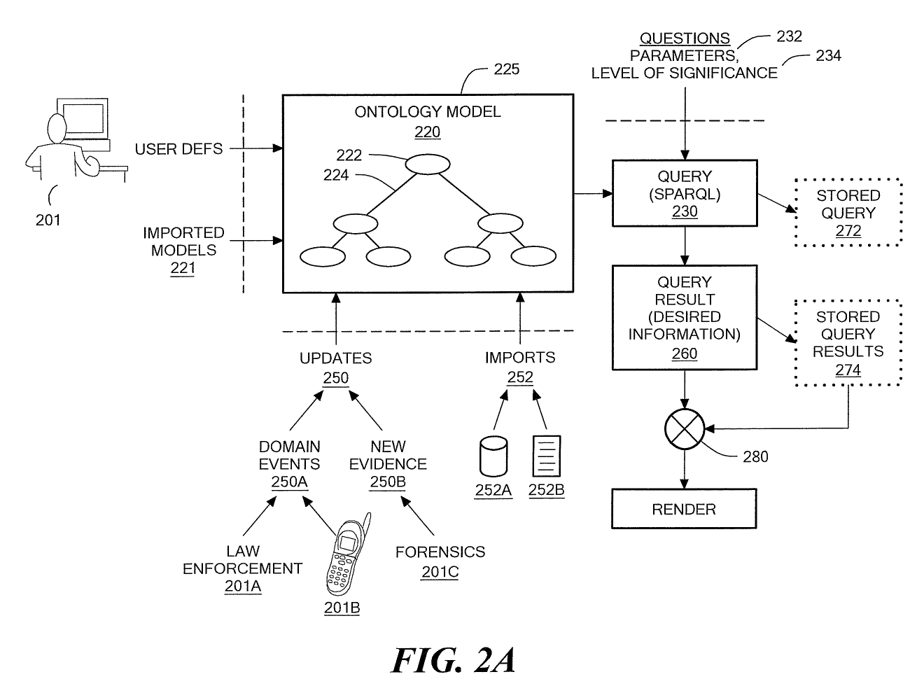

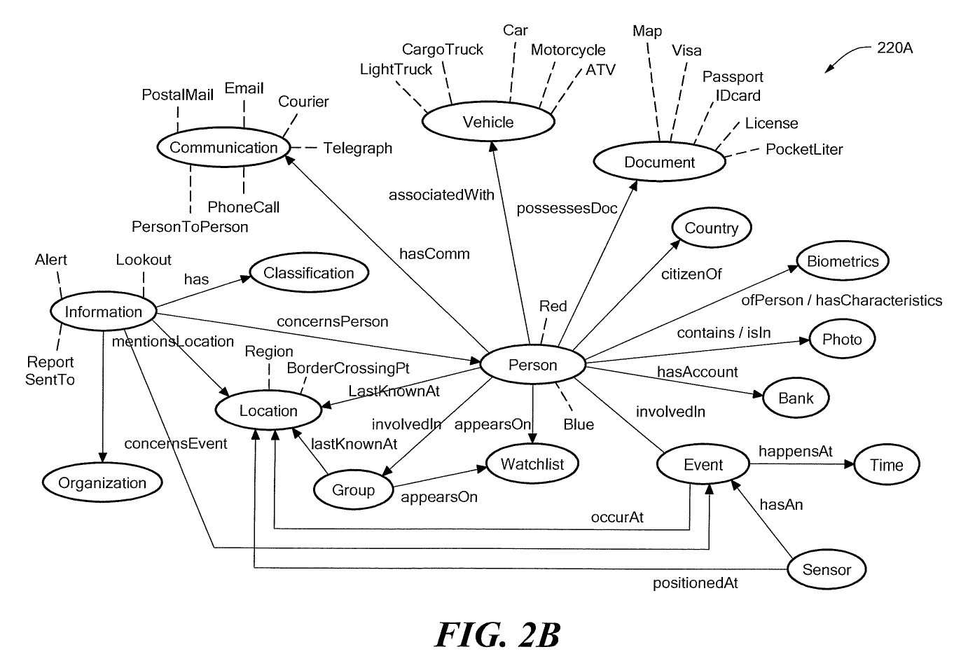

Referring now to FIG. 2A, in one embodiment of the concepts, techniques, and systems, an ontology model 220 includes concepts 222 and relationships 224 to represent a domain space. The ontology model 220 may be defined by domain users 201 and/or a portion, all, or none of the ontology model may be imported 221 from a preexisting model, such as one that is published to support decision-making in a particular problem space. For example, a border security model may be imported for use with the inventive concepts, techniques, and systems.

FIG. 2B illustrates an example ontology model 220A of the type which may be used by the inventive concepts, techniques, and system. Various techniques may be used to author the ontology model 220. As by non-limiting example, one known authorizing technique includes the use of the Ontology Web Language (OWL) which is a family of knowledge representation languages for authoring ontologies and is endorsed by the World Wide Web Consortium. Other authoring languages may, of course, also be used.

Referring again to FIG. 2A, a domain user and/or machine may execute a query 230 to receive a query result 260 to identify desired information from the ontology model 220. In one embodiment, the query 230 includes query parameters 232 and/or a level of significance 234. In one example, a query 230 is written using SPARQL and may include the following syntax:

```
        PREFIX Mastery: <http://example.com/BorderSecurity#>
SELECT ?associate ? suspect
WHERE {
  ?x Mastery:associateName ?associate ;
    Mastery:isAssociateOf ?y .and Master:hasCrossedBorder
  ?y Mastery:suspectName ?suspect ;
    Mastery:isInTerrorCell Mastery:Cell_011
}
```

The SPARQL query returns the associates of suspects (and the suspects) who are members of a terror cell. Here, Mastery is a prefix for referring to an ontology model for border security, located at the indicated http: web address. The border security ontology model may include instances of terror cells and suspects who are members of the terror cells. Each suspect may have one or more associates who are known to conspire with the suspect in terror-related plots and activities.

The SELECT statement indicates the desired information to retrieve from the model based on the query logic within the WHERE statement, including associates and suspects from the ontology model. As can be seen from the query logic, the query result will include all associates of suspects who are members of the “Cell_{—}011” terror cell, where the associates have crossed the border into the United States.

It should be noted that the border crossings may be stored directly in the border security ontology as model instances, or the query may cause an external system to return a list of all associates who have crossed the border into the United States within some predefined time period.

In the same or different embodiment, a query 230 may include a level of significance 234 of the desired information. For example, the level of significance 234 may be a numerical value to indicate the significance of desired information. In one exemplary embodiment, for example, a numerical value which is near the high end of a range of numerical values may indicate that the level of significance of desired information is high, while a numerical value which is near the low end of a range of numerical values may indicate that the level of significance of desired information is low. The level of significance 234 may be based on an amount of desired information that is received, for example, a number of associates affiliated with an organized crime syndicate. This may be particularly useful when the amount of returned associates corresponds to a high-degree of activity in a crime syndicate. Here, the level of significance 234 helps to direct a crime investigator's attention to increased criminal activity.

Referring again to FIG. 2A, in a further embodiment, a query 230 is stored in a memory 272 for re-execution. In still a further embodiment, the query results 260 from one or more executions of query 230 are stored in a memory 274 for comparison 280 with each other. Domain users may be concerned with differences between query results which may reveal changed or modified domain information in the ontology model 220. In one non-limiting example, a comparison 280 may include comparing a first set of returned information with a second set of returned information to reveal any differences therein. For example, a first set of returned information in a first query result may include A1 and A2, and a second set of returned information in a second query result may include A2 and A3. Here, the differences include A1 and A3. In another non-limiting example, domain users may be concerned with changes in a quantity of a domain attribute. Here, a comparison 280 may be between returned ranges. For example, a monetary value of a suspect's assets may have increased between a first query result and a second query result. It should readily apparent to one of ordinary skill in the art that comparisons are not limited to those of the type described above, and may include most any comparison relevant to the type of desired information.

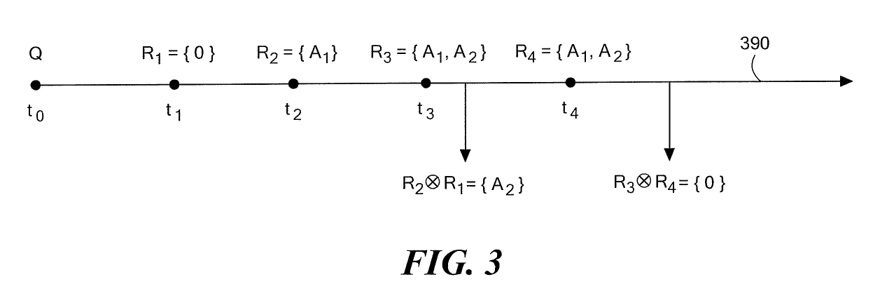

Referring now to FIG. 3, in one embodiment, a query Q may be defined and stored for repeated execution. When desired information is identified from a query result, the desired information is rendered. As shown on timeline 390, a query Q may be defined at time t₀ and stored in a memory. At time t₁, query Q is executed yielding query result R₁, which includes no query results as indicated by a null value between brackets { }. Thus, in response to query Q, executed at time t₁, no desired information is identified.

At time t₂, query Q is re-executed to return R₂={A₁}. Here, A₁ is identified as desired information and rendered. As can be seen from this example, domain information has changed between time t₁ and t₂. In particular, A₁ has occurred somewhere between time t₁ and time t₂. Advantageously, a domain user need not be informed of the results of the query at time t₁, since it contains no desired information. However, a domain user can be informed of the results of query Q at time t₂, since it reveals that A₁ has occurred.

For example, in the above example involving a query to receive associates crossing into the United States, it may be that no associates have crossed into the United States at or before time t₁, however, between time t₁ and time t₂, associate A₁ crossed into the United States.

Referring again to FIG. 3, in the same or different embodiment, a query Q is executed at different times to receive query results (generally denoted by R) that are compared with each other to identify and render desired information. In one example, the desired information is a difference between query results executed at different times, which indicates information that has been changed or modified in an ontology model since one or more less recent query executions. For example, at time t₂, query Q is executed to return query result R₂={A₁}. R₂ is compared with an earlier query result in which the result set was null, and A₁ is identified as the difference between the query results and is rendered.

At time t₃, query Q is executed to return query result R₃={A₁, A₂}. Here, R₂ and R₃ are compared to identify difference A₂ and A₂ is rendered. At time t₄, query Q is executed to return query result R₄={A₁, A₂}. Since no information has changed, no results are rendered.

Advantageously, the desired information includes only information that has been changed and/or modified between executions. Therefore, domain users may execute queries unattended in the background, and focus their time and efforts on other tasks. When desired information is identified, domain users are notified so that they may revisit and/or attend to the case.

Referring again to FIG. 2A, in one embodiment, an ontology model 220 receives updates 250 to add, remove, and/or modify domain concepts and relationships, instances of the ontology, and/or domain events. For example, updates 250 to the ontology model 220 may include uploaded information entered by a joint responder, such as a law enforcement official 201A, at a scene of an accident. For example, the joint responder may enter suspect attribute information from eyewitness reports at the scene of the accident.

In one embodiment, an update 250 includes a domain event 250B. For example, a border crossing tracking system may submit information related to a tracked suspect's crossing into the United States. The tracking system may submit the event as a XML file encoding the name of the suspect, a location of the crossing (i.e., the crossing facility), and/or a date/time of the crossing. Such information is received by the modeler 225 which parses the data and adds it (and/or modifies an existing instance of the suspect) to the ontology model 220.

In another embodiment, the information is entered on a device 201B, such as a hand-held personal assistant, formatted in Extensible Markup Language (XML) and submitted as an XML file to an ontology modeler 225. The ontology modeler 225 receives the information and modifies the ontology model 220, for example, by parsing the XML file contents, and adding it to the model 220.

In a further embodiment, an update 250 includes relevant evidence 250B in a criminal investigation, such as finger print attributes entered by forensics 201B.

In one embodiment, an ontology model 220 receives data imports 252, which may include predefined catalogs of information and/or taxonomies. A non-limiting example of a catalog includes a classification of automobile makes and models by year of manufacture. Such data imports 252 may be received from databases 252A, such as proprietary databases, and/or data files 252B. Other data sources include public registries, such as a motor vehicle registry of registered state drivers. Still other data may be highly-classified data, such as terror suspects.

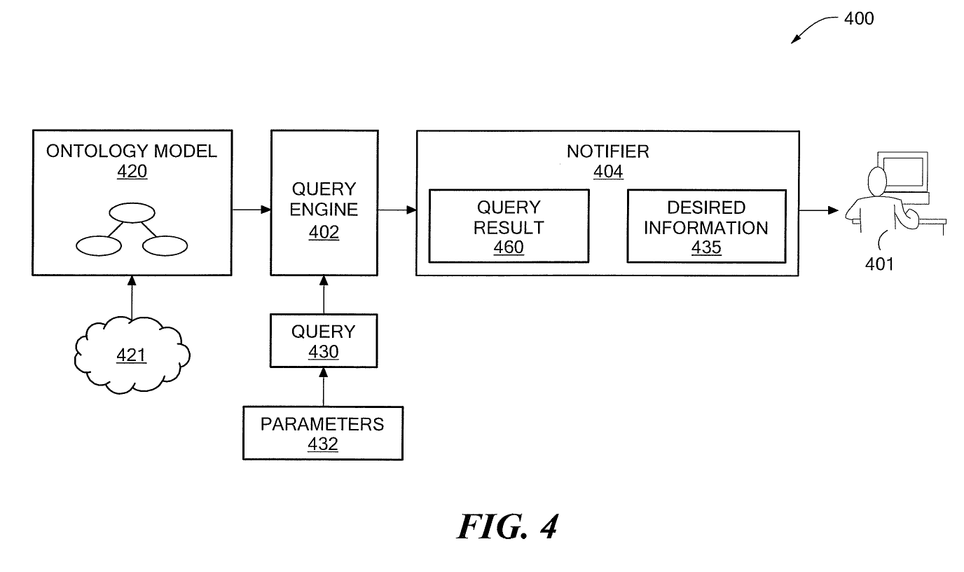

Referring now to FIG. 4, in one aspect, a system 400 for querying information in an ontology model 420 representing domain information 421 includes a query engine 402 to execute a query 430 of the ontology model 420 for desired domain information 435 based on at least one parameter 432. The system 400 further includes a notifier 404 to process a query result 460 to identify and render any of the desired domain information 435. In one embodiment, the notifier 404 enables the output of the desire domain information 435 to a user 401, such as a desktop computer user, a hand-held device user, a user in a mobile environment, etc. The desired domain information 435 may be outputted over a wired network, a wireless network, or a combination thereof. In the same or different embodiment, the notifier 404 may render the desired information as an electronic mail message and/or a text message sent to a user. As by non-limiting example, the text message may be sent via a text-messaging system such as a chat server and/or an instant-messaging system.

In a further embodiment, an ontology model 420 is represented in a relational database which may include database tables to represent the domain concepts, and linkages between database tables to represent the relationships between the concepts. Separate rows of a database table may represent instances of the ontology model.

The query engine 402 and the notifier 404 may be one or more software modules loaded from a memory and executed in a computer processor. Programmers may write source code for the one or more software modules in a programming language, such as Java or C#. The programmers compile and debug the software modules, and test the software modules, which may include the use of an Integrated Development Environment for sharing code and importing software libraries.

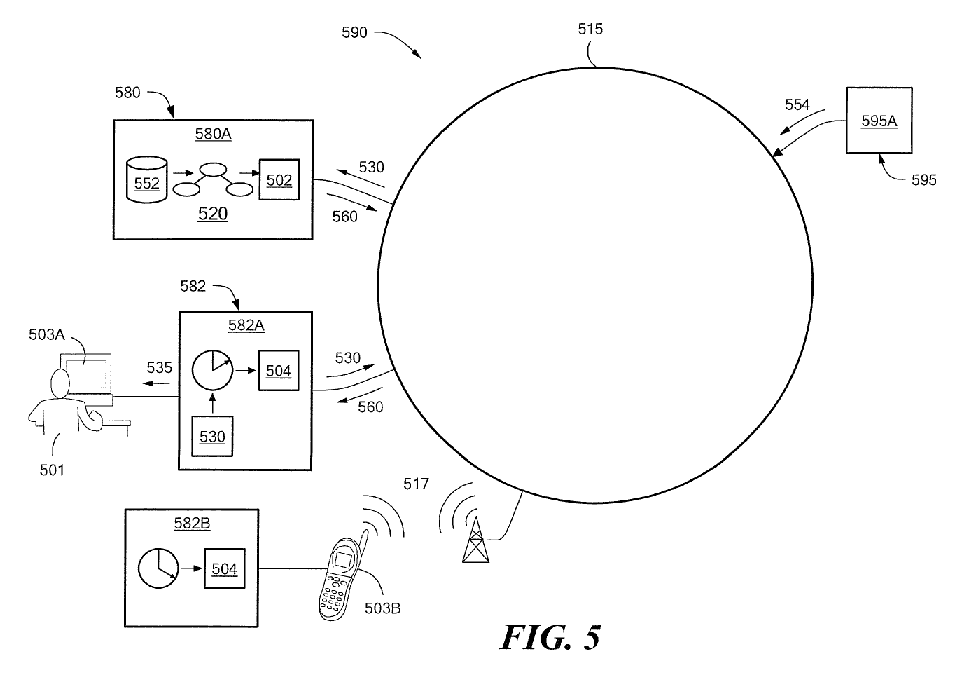

Referring now to FIG. 5, a networked environment 590 which may incorporate the inventive concepts, techniques, and systems includes servers 580 and clients 582 communicating over a network 515, which may include the Internet, an intranet, a private network, or a combination thereof. In one embodiment, a server 580A includes an ontology model 520 for representing a domain space, as may be similar to ontology model 120 described in conjunction with FIG. 1. The server 580A may also include a database 552 to organize and store the model 520. The server 580A may receive data imports from external systems 595. In one non-limiting example, a border security application includes a border security ontology that imports border security data and event information from a border crossing tracking system 595A.

In one embodiment, a client 582A generates queries 530 of the ontology model 520 to pose questions and to receive desired domain information. The queries 530 may be submitted to the server 580A, where a query engine 502 receives and executes the queries 530. The server 580A returns a query result 560 to the client 582A, where a notifier 504 identifies and renders any desired domain information 535. For example, the notifier 504 may output the desired domain information to a computer 503A for display on a display screen where it may be viewed by a user 501.

In still another embodiment, the client 582A stores a query 530 and submits the query at a predetermined time interval 540. In another embodiment, the client 582A sends a request along with the predetermined time interval 540 to the server 580A, where the query 530 is executed. Such a request may include a number of times to re-execute the query 530.

In another embodiment, a client 582B communicates over a wireless network 517 to a server 580A. The client 582B may include a portable, hand-held device 503B for use by, for example, a military operative on the battlefield.

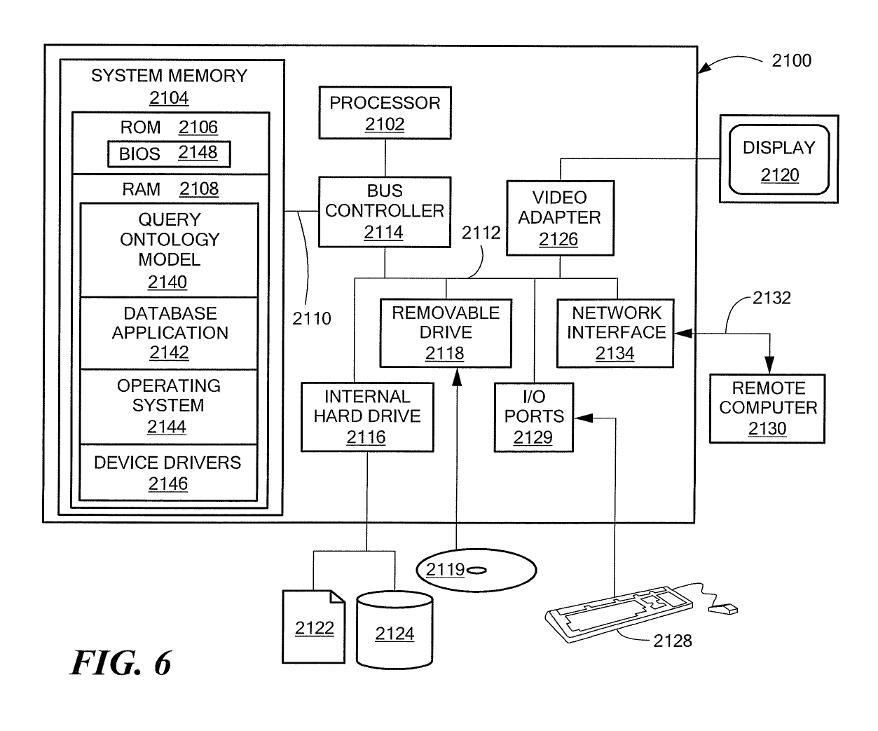

FIG. 6 illustrates a processing system or computer 2100 suitable for supporting the operation of an embodiment of the inventive concepts and systems described herein. The computer 2100 includes a processor 2102, for example, a dual-core processor, such as the AMD Athlon™ X2 Dual Core processor from the Advanced Micro Devices Corporation. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing a machine-based method or system similar to that described in conjunction with the figures. Desired information, such as desired information described in conjunction with FIG. 1, may be outputted to display 2120. For example, border crossing information related to a member of a terror cell may be outputted to display 2120 to enable homeland security operations.

Components of the inventive concepts, techniques, and systems described herein may be implemented in one or more of the computer-readable modules. For example, a query engine, a notifier, and an ontology model similar to those described in conjunction with FIG. 4 may be implemented in separate computer-readable modules.

In a further embodiment, the computer 2100 may execute the computer-readable modules on separate processors to increase response time and for fault tolerance. For example, a query engine and an ontology model may be executed on a first processor and a notifier may be executed on a second processor. The first and second processor may be respective processors of a dual-core processor.

Alternatively, the first and second processor may be respective first and second computing devices. In a further embodiment, the query engine and ontology model is executed on a server machine and the notifier is executed on a client machine. For example, the query engine may send a query result over a network to the notifier, where any desired information is identified and rendered to a client user.

In a further embodiment, a query and/or a query result is stored in memory 2108. For example, the query may be stored and reloaded for re-execution and a first query result of the query may be stored and compared with a second query result of the query (executed at a different time).

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims

What is claimed is:

1. A machine-based method for querying information in an ontology model, comprising:
providing an ontology model which represents domain information;
executing a query of the ontology model, the query directed to identify desired domain information based upon at least one parameter;
processing a query result to identify any of the desired domain information; and
in response to identifying desired domain information, rendering the desired domain information.

2. The method of claim 1, further comprising:
at a predetermined time interval, re-executing the query to receive a new query result,
wherein at least a portion of the desired domain information is processed from the new query result.

3. The method of claim 1, further comprising:
in response to modified domain information, re-executing the query to receive a new query result,
wherein at least a portion of the desired domain information is processed from the new query result.

4. The method of claim 1, wherein the query is stored in a memory to execute at a first time and at a second time different than the first time, and the query result includes:
a first query result received at the first time; and
a second query result received at the second time,
wherein processing the desired domain information includes comparing the first query result and the second query result.

5. The method of claim 1, wherein rendering the desired information includes outputting at least one of: an electronic mail message and an instant text message.

6. The method of claim 1, wherein the domain information includes domain event information associated with domain events, further comprising:
receiving the domain event information; and
processing the received domain event information by modifying at least one of: instances of the ontology model, and relationships of the ontology model.

7. The method of claim 1, further comprising:
importing domain information into the ontology model, the imported domain information including at least one of: an ontology model relationship, and an instance of the ontology model.

8. A system for querying information in an ontology model, comprising:
an ontology model to represent domain information;
a query engine to execute a query of the ontology model, the query directed to identify desired domain information based on at least one parameter; and
a notifier to process a query result to identify and render any of the desired domain information.

9. The system of claim 8, wherein the query engine re-executes the query at a predetermined time interval to receive a new query result, and at least a portion of the desired domain information is identified from the new query result.

10. The system of claim 8, wherein, in response to modified domain information, the query engine re-executes the query to receive a new query result, and at least a portion of the desired domain information is identified from the new query result.

11. The system of claim 8, wherein the query is stored in a memory and the query engine executes the stored query at a first time to receive a first query result and at a second time different than the first time to receive a second query result, and the notifier identifies and renders the desired domain information by comparing the first query result and the second query result.

12. The system of claim 8, wherein the notifier enables the output of at least one of: an electronic mail message and an instant text message.

13. The system of claim 8, further comprising:
an updater to receive domain event information associated with domain events and to process the received domain event information by modifying at least one of: instances of the ontology model, and relationships of the ontology model.

14. The system of claim 8, further comprising:
an importer to import domain information into the ontology model, the imported domain information including at least one of: an ontology model relationship, and an instance of the ontology model.

15. An article, comprising:
a storage medium having stored instruction thereon that when executed by a processor result in the following:
a ontology model to represent domain information;
a query engine to execute a query of the ontology model, the query directed to identify desired domain information based upon at least one parameter; and
a notifier to process a query result to identify and render any of the desired domain information.
